(19) United States
(12) Patent Application Publication
(10) Pub. No.: US 2021/0293263 A1
(43) Pub. Date: Sep. 23, 2021

(54) FASTENING STRUCTURE AND DEVICE

(71) Applicant: FUJIFILM Business Innovation Corp., Tokyo (JP)

(72) Inventors: Michiaki YOSHIDA, Kanagawa (JP); Kazuo TAKANO, Kanagawa (JP)

(73) Assignee: FUJIFILM Business Innovation Corp., Tokyo (JP)

(21) Appl. No.: 16/984,109

(22) Filed: Aug. 3, 2020

(30) Foreign Application Priority Data
Mar. 19, 2020 (JP) 2020-048752

(51) Int. Cl. F16B 5/06

(52) U.S. Cl. CPC F16B 5/0614

(57) ABSTRACT

A fastening structure includes a fastening portion. The fastening portion moves in a movement direction between a first position and a second position. The first position and the second position are two positions in which the fastening portion is at least partially inserted into a hole of a to-be-supported portion. The fastening portion in the first position or the second position receives resistance to further movement in a direction in which the fastening portion is moved to the first position or the second position. The fastening portion in the first position unremovably fastens the to-be-supported portion to a support portion. The fastening portion in the second position allows the to-be-supported portion to be removed from the support portion while being supported by the to-be-supported portion.

### CROSS-REFERENCE TO RELATED APPLICATIONS

This application is based on and claims priority under 35 USC 119 from Japanese Patent Application No. 2020-048752 filed Mar. 19, 2020.

### BACKGROUND

### (i) Technical Field

The present disclosure relates to a fastening structure and a device.

### (ii) Related Art

Housings of typical devices have a fastening structure for fastening different components together. Here, examples of a fastening structure for fastening panels constituting device housings include screw fixation and snap-fit. Panels constituting the housings form the exterior surfaces of the device, for which screw fixation is less preferable from the design point of view. Snap-fit, on the other hand, is more advantageous than screw fixation in terms of appearance. However, from the fixation viewpoint, a snap-fit structure is not suitable for firm fastening and is easily removable. To fasten panels or other components that are not removed in daily use but removed as appropriate for maintenance or other occasions, for example, a method including both screw fixation and snap-fit together is conceivable, for example, a panel is fixed with screws at some portions concealed under another panel while the panel is fixed with snap-fit not to fall immediately after being unscrewed. This structure involves two fastening methods, and is complex with screwing at portions not finally forming the exterior and covering the screwed portions with another panel. In addition, after unscrewing with insufficient management, screws may be lost or, in some cases, enter the inside of the device to cause an error.

Here, Japanese Unexamined Utility Model Registration Application Publication No. 6-18706 discloses a clip body that is inserted into and twisted in two holes respectively formed in two members to fasten these two members together.

### SUMMARY

Aspects of non-limiting embodiments of the present disclosure relate to a fastening structure that includes a fastening portion to support a to-be-supported portion on a support portion while moving the fastening portion to change the fastening level between firm fastening disabling removal and loose fastening enabling removal, and also relate to a device including the fastening structure.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fastening structure that includes a fastening portion. The fastening portion moves in a movement direction between a first position and a second position, which are two positions in which the fastening portion is at least partially inserted into a hole of a to-be-supported portion. The fastening portion in the first position or the second position receives resistance to further movement in a direction in which the fastening portion is moved to the first position or the second position. The fastening portion in the first position unremovably fastens the to-be-supported portion to a support portion. The fastening portion in the second position allows the to-be-supported portion to be removed from the support portion while being supported by the to-be-supported portion.

### BRIEF DESCRIPTION OF THE DRAWINGS

Exemplary embodiments of the present disclosure will be described in detail based on the following figures, wherein:

FIG. 1 is a perspective view of a fastening structure according to a first exemplary embodiment of the present disclosure;

FIG. 2 is an enlarged perspective view of a fastening member;

FIG. 3 is a schematic cross-sectional view of a support structure of a fastening member illustrated in FIG. 2;

FIG. 4 is a schematic cross-sectional view of a support structure of a fastening member illustrated in FIG. 2;

FIG. 5 is a perspective view of a support structure according to a second exemplary embodiment;

FIG. 6 is a schematic cross-sectional view of the support structure according to the second exemplary embodiment;

FIG. 7 is a perspective view of the support structure according to the second exemplary embodiment;

FIG. 8 is a schematic cross-sectional view of the support structure according to the second exemplary embodiment;

FIG. 9 is a schematic cross-sectional view of a support structure according to a third exemplary embodiment;

FIG. 10 is a schematic cross-sectional view of the support structure according to the third exemplary embodiment;

FIG. 11 is a schematic cross-sectional view of a support structure according to a fourth exemplary embodiment;

FIG. 12 is a schematic cross-sectional view of the support structure according to the fourth exemplary embodiment;

FIG. 13 is a cross-sectional view of a fastening member taken along line XIII-XIII and viewed in the direction of arrows in FIG. 11;

FIG. 14 is a schematic cross-sectional view of a support structure according to a fifth exemplary embodiment;

FIG. 15 is a schematic cross-sectional view of the support structure according to the fifth exemplary embodiment; and

FIGS. 16A and 16B are cross-sectional views of a fastening member constituting the support structure according to the fifth exemplary embodiment.

### DETAILED DESCRIPTION

Exemplary embodiments of the present disclosure will be described, below.

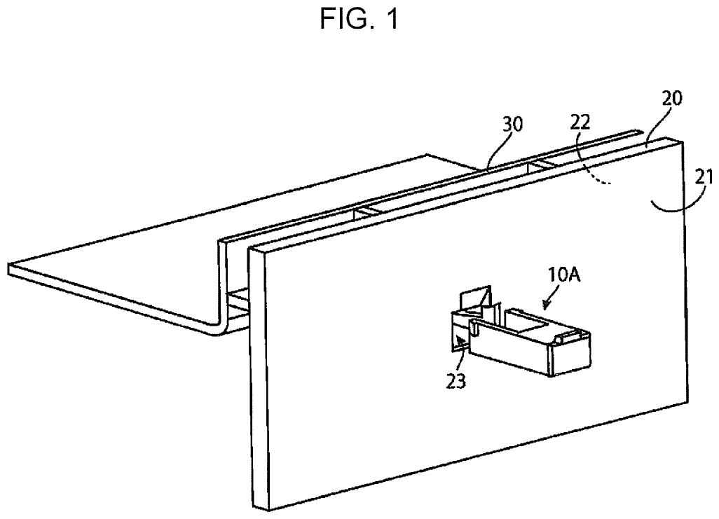

FIG. 1 is a perspective view of a fastening structure according to a first exemplary embodiment of the present disclosure.

FIG. 1 illustrates a fastening member 10A, a panel 20, and a metal plate 30.

The metal plate 30 is a component constituting part of a frame of a device, not illustrated. The panel 20 is a component fastened to the metal plate 30 and constituting the outer surface of the device. The fastening member 10A is a component fastening the panel 20 to the metal plate 30. Here, the fastening member 10A corresponds to an example of a fastening portion in the present disclosure. The panel 20 and the metal plate 30 respectively correspond to examples of a to-be-supported portion and a support portion in the present disclosure.

The panel 20 has an outer surface 21 and a back surface 22, and a through-hole 23, which extends through the outer surface 21 and the back surface 22. The fastening member 10A is inserted into the through-hole 23 from the outer surface 21 to fasten the panel 20 to the metal plate 30 disposed on the back surface 22 of the panel 20. At least part of the fastening member 10A slides within a range in which it is inserted into the through-hole 23 between a first position, in which the fastening member 10A firmly fastens the panel 20 to the metal plate 30 to prevent the panel 20 from being removed from the metal plate 30, and a second position, in which the fastening member 10A allows the panel 20 to be removed from the metal plate 30. When the panel 20 is removed from the metal plate 30, the fastening member 10A is also removed from the metal plate 30 while being supported by the panel 20.

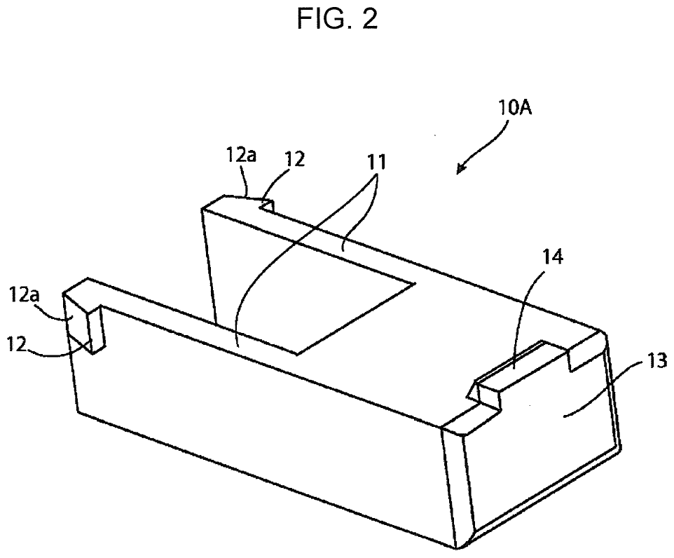

FIG. 2 is an enlarged perspective view of a fastening member.

The fastening member 10A includes two arms 11, extending in a cantilever form in a direction in which the fastening member 10A is inserted into the through-hole 23 illustrated in FIG. 1. The fastening member 10A includes abutting portions 12 at the distal ends of the arms 11. A side surface 12a of each abutting portion 12 is a tapering slope. When the fastening member 10A is inserted into the through-hole 23 of the panel 20, the side surfaces 12a abut against the edge of the through-hole 23. When the fastening member 10A is pushed in, the two arms 11 are bent toward each other to pass through the through-hole 23. When the abutting portions 12 pass the back surface 22 of the panel 20, the two arms 11 are released from being bent. When the fastening member 10A is to be pulled out of the panel 20, the abutting portions 12 abut against the back surface 22 of the panel 20 to keep the fastening member 10A supported by the panel 20. However, if the two arms 11 are intentionally bent inward, the fastening member 10A is removable from the panel 20.

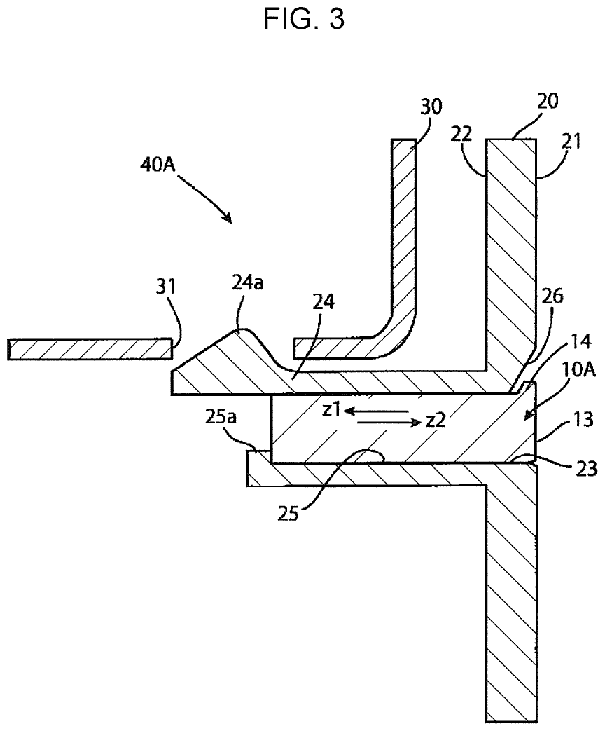

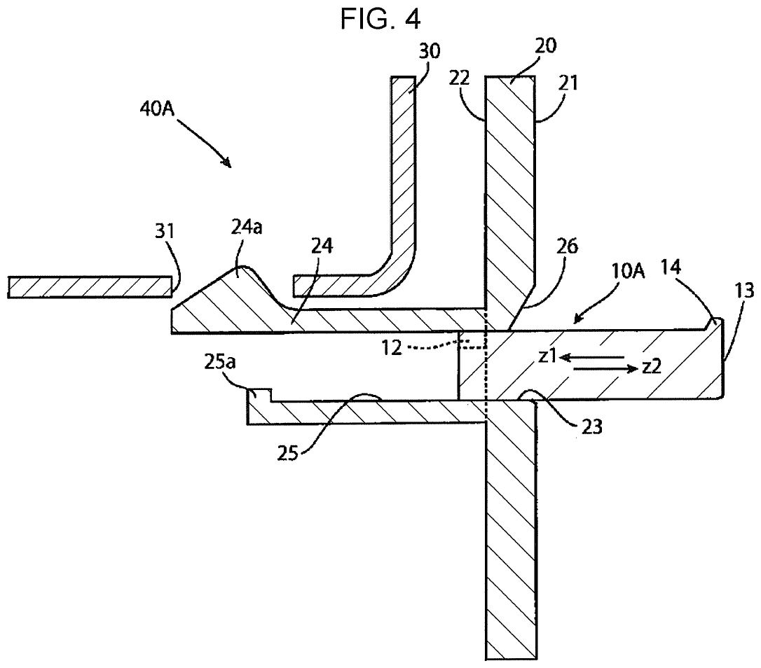

FIGS. 3 and 4 are schematic cross-sectional views of a support structure of a fastening member illustrated in FIG. 2. Here, FIG. 3 illustrates the fastening member 10A in a first position where it firmly fastens the panel 20 to the metal plate 30 to prevent the panel 20 from being removed from the metal plate 30. FIG. 4 illustrates the fastening member 10A in a second position where it allows the panel 20 to be removed from the metal plate 30.

The support structure 40A illustrated in FIGS. 3 and 4 corresponds to a support structure according to a first exemplary embodiment of the present disclosure, and includes a fastening tongue 24 disposed on the panel 20, a fastening hole 31 formed in the metal plate 30, and the fastening member 10A illustrated in FIG. 2. The fastening tongue 24 extends in a cantilever form in the direction of arrow z1 and includes a crook 24a, which is disposed at the distal end to swell upward. This crook 24a is inserted into the fastening hole 31 to fasten the panel 20 to the metal plate 30. The panel 20 includes a base 25, on which the fastening member 10A is movably mounted. The fastening tongue 24 and the base 25 are spaced by a gap in which the fastening member 10A is receivable. The fastening member 10A is inserted into the gap. The base 25 has a stopper 25a at the distal end. The stopper 25a stands erect into a hook form. When the fastening member 10A is inserted through the through-hole 23 furthest in the direction of arrow z1, the fastening member 10A abuts against the stopper 25a and fails to be inserted further. When the fastening member 10A is positioned to be in contact with the stopper 25a, a rear end surface 13 of the fastening member 10A is flush with the outer surface 21 of the panel 20 to form a part of the outer surface of the device. When the fastening member 10A is positioned to be in contact with the stopper 25a, the fastening tongue 24 is left without being bent while being unremovable from the fastening hole 31 with the crook 24a kept in the fastening hole 31. Specifically, the position of the fastening member 10A illustrated in FIG. 3 is the first position where the fastening member 10A firmly fastens the panel 20 to the metal plate 30 to prevent the panel 20 from being removed. When the fastening member 10A is in the first position, the fastening member 10A receives force from the fastening tongue 24 to be left in the first position unless being intentionally pulled out.

The fastening hole 31 formed in the metal plate 30 may have any structure that interferes with the crook 24a to fasten the panel 20 to the metal plate 30. For example, the fastening hole 31 may be a recess, a cut, an end surface, or a folded portion.

The fastening member 10A includes a hook 14, protruding upward to allow a tool (not illustrated) to be hooked thereon. The panel 20 also has a chamfer 26 above the through-hole 23 to form a path for a tool approaching the hook 14 of the fastening member 10A in the first position illustrated in FIG. 3. A tool is hooked on the hook 14 of the fastening member 10A in the first position illustrated in FIG. 3 to pull out the fastening member 10A in the direction of arrow z2. The hook 14 may have a structure that allows a finger or a nail to be hooked thereon without using a tool.

When the fastening member 10A is pulled out furthest in the direction of arrow z2, the abutting portions 12 abut against the back surface 22 of the panel 20 around the through-hole 23 to prevent the fastening member 10A from being pulled out further. When the fastening member 10A is in the position illustrated in FIG. 4, the fastening tongue 24 is bendable. When the panel 20 receives a force of removing the panel 20, the crook 24a is removed from the fastening hole 31 to allow the panel 20 to be removed from the metal plate 30. Here, the fastening member 10A is left supported by the panel 20 while being held in the through-hole 23.

Here, in the support structure illustrated in FIGS. 3 and 4, the fastening tongue 24 corresponds to an example of a first portion of the present disclosure, and the fastening hole 31 corresponds to an example of a second portion of the present disclosure.

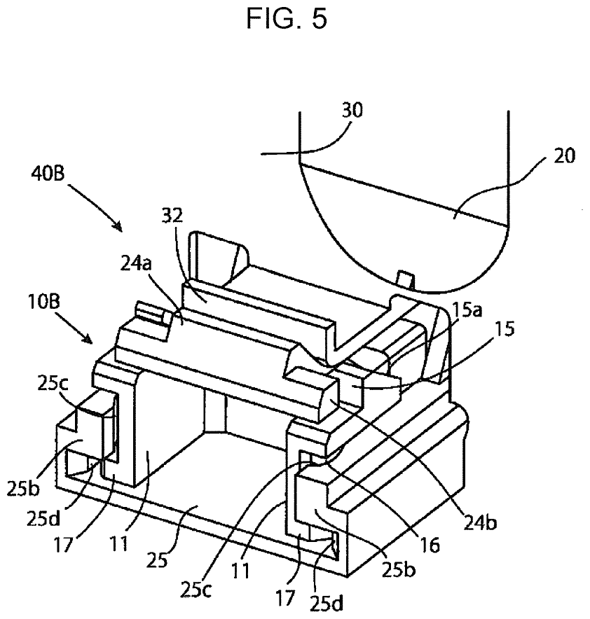

FIG. 5 is a perspective view of a support structure according to a second exemplary embodiment.

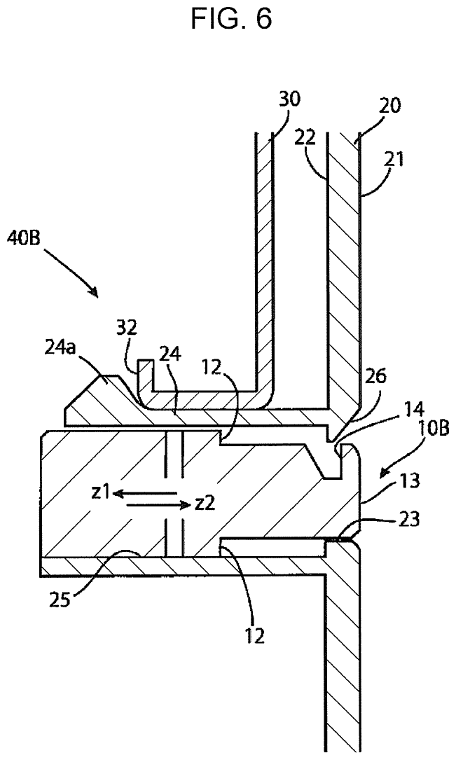

FIG. 6 is a schematic cross-sectional view of the support structure according to the second exemplary embodiment.

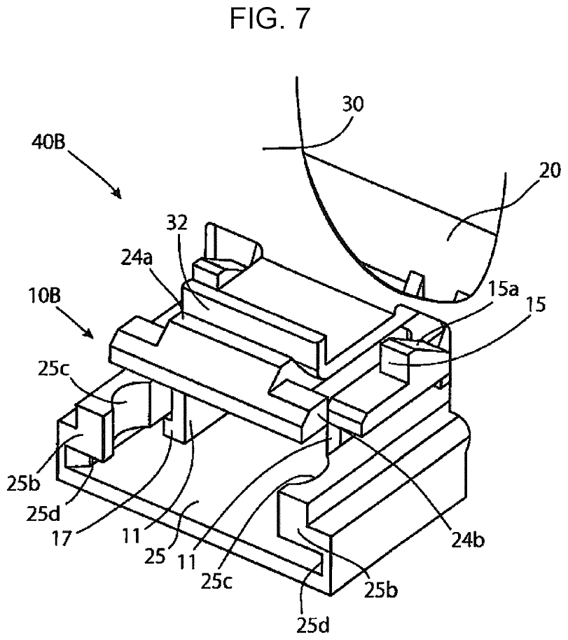

As in FIG. 5, FIG. 7 is a perspective view of the support structure according to the second exemplary embodiment.

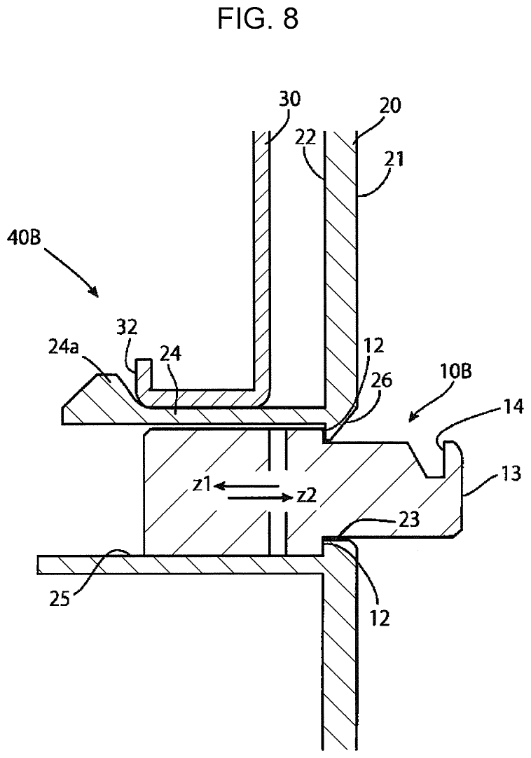

As in FIG. 6, FIG. 8 is a schematic cross-sectional view of the support structure according to the second exemplary embodiment.

The support structure according to the second exemplary embodiment illustrated in FIGS. 5 to 8 includes a fastening member 10B according to the second exemplary embodiment of the present disclosure.

Here, FIGS. 5 and 6 illustrate the fastening member 10B in the first position where the fastening member 10B prevents the panel 20 from being removed from the metal plate 30. On the other hand, FIGS. 7 and 8 illustrate the fastening member 10B in the second position where the fastening member 10B allows the panel 20 to be removed from the metal plate 30.

In the second exemplary embodiment illustrated in FIGS. 5 to 8, for ease of understanding, components corresponding to the components denoted with the reference signs in the above first exemplary embodiment are denoted with reference sings the same as those of the first exemplary embodiment even having difference in shape or other properties. The same holds true to the third exemplary embodiment and the following exemplary embodiments.

As illustrated in FIG. 6, a support structure 40B according to the second exemplary embodiment includes a fastening tongue 24 included in the panel 20, a fastening bent portion 32 included in the metal plate 30, and the fastening member 10B.

As in the fastening member 10A according to the first exemplary embodiment, the fastening member 10B according to the second exemplary embodiment includes two arms 11 arranged side by side as illustrated in FIG. 5, which are bendable leftward and rightward. However, the fastening member 10B is not vertically bendable. Referring now to FIG. 8, protruding portions 12 of the fastening member 10B, which abut against the back surface 22 of the panel 20, form stepped portions protruding vertically. Thus, the fastening member 10B is not insertable into the through-hole 23 of the panel 20 from the outer surface 21 of the panel 20. The fastening member 10B according to the second exemplary embodiment is inserted into the through-hole 23 from the back surface 22 of the panel 20.

In this structure, the fastening member 10B is inserted into the through-hole 23 from the back surface 22 of the panel 20. Compared to the fastening member 10A according to the first exemplary embodiment, the through-hole 23 is smaller, and the rear end surface 13 of the fastening member 10B is smaller. Thus, the fastening member 10B improves its design viewed from the outer surface 21 of the panel 20.

Here, as illustrated in FIG. 5, the fastening tongue 24 of the panel 20 includes protrusion receiving portions 24b on the left and right sides. The fastening member 10B, on the other hand, includes contact walls 15, on the left and right sides, against which the protrusion receiving portions 24b abut. Each contact wall 15 has a chamfer 15a. When the fastening member 10B is inserted into the through-hole 23 of the panel 20, the chamfers 15a allow the contact walls 15 to be elastically deformed in a direction to raise the fastening tongue 24 of the panel 20 so that the contact walls 15 cross over the fastening tongue 24 toward the back surface 22 of the panel 20. After the contact walls 15 cross over, as illustrated in FIG. 5, the protrusion receiving portions 24b of the fastening tongue 24 are positioned at such a level as to interfere with the contact walls 15. When the fastening member 10B is moved to the position illustrated in FIGS. 5 and 6, at which the fastening member 10B is inserted into the through-hole 23 furthest, the contact walls 15 abut against the protrusion receiving portions 24b, and are not inserted further. When the fastening member 10B is in the furthest inserted position, as in the case of the fastening member 10A according to the first exemplary embodiment, the rear end surface 13 of the fastening member 10B is flush with the outer surface 21 of the panel 20 to form part of the outer surface of the device.

Here, the crook 24a of the fastening tongue 24 is hooked on the fastening bent portion 32 of the metal plate 30. When the fastening member 10B is in the furthest inserted position illustrated in FIGS. 5 and 6, the fastening tongue 24 is prevented from being bent. Thus, the panel 20 is unremovably fastened to the metal plate 30. Specifically, also in the second exemplary embodiment, the position in which the fastening member 10B is inserted furthest corresponds to a first position in the present disclosure.

In the second exemplary embodiment, the base 25 of the panel 20 that allows the fastening member 10B to be movably mounted thereon includes walls 25b, which stand erect on the left and side sides. Each of the walls 25b has a recess 25c, which is open inward. The left and right arms 11 of the fastening member 10B each include a swell 16, which swells outward. When the fastening member 10B is moved to the furthest inserted position illustrated in FIGS. 5 and 6, the swells 16 enter the recesses 25c to prevent the fastening member 10B from accidentally moving from the position.

The base 25 also has guide grooves 25d on the left and right to guide movement of the fastening member 10B. Correspondingly, the fastening member 10B includes guided portions 17, protruding outward and received in the guide grooves 25d. When the fastening member 10B moves, the guided portions 17 are guided by the guide grooves 25d so that the fastening member 10B is smoothly movable in the directions of arrows z1 and z2 illustrated in FIG. 6.

The hook 14 of the fastening member 10B on which a tool is hooked has a groove shape. The panel 20 has a chamfer 26 above the through-hole 23. The chamfer 26 forms a path for a tool to be hooked on the hook 14 of the fastening member 10B. When the fastening member 10B is in the position illustrated in FIGS. 5 and 6, a tool is moved along the chamfer 26 to be hooked on the hook 14 to pull out the fastening member 10B in the direction of arrow z2.

FIGS. 7 and 8 illustrate the support structure 40B when the fastening member 10B is pulled out furthest in the direction of arrow z2. When the fastening member 10B is pulled out furthest in the direction of arrow z2, the abutting portions 12 disposed at the upper and lower portions of the fastening member 10B abut against the back surface 22 of the panel 20. When the fastening member 10B is pulled out until the abutting portions 12 abut against the back surface 22 of the panel 20, the fastening tongue 24 is allowed to bend. When the panel 20 receives force of removal, the crook 24a is removed from the fastening bent portion 32, so that the panel 20 is removed from the metal plate 30. Here, the fastening member 10B is left supported by the panel 20 while being held in the through-hole 23.

In the support structure 40B illustrated in FIGS. 6 and 8, the fastening tongue 24 corresponds to an example of a first portion of the present disclosure, and the fastening bent portion 32 corresponds to an example of a second portion of the present disclosure.

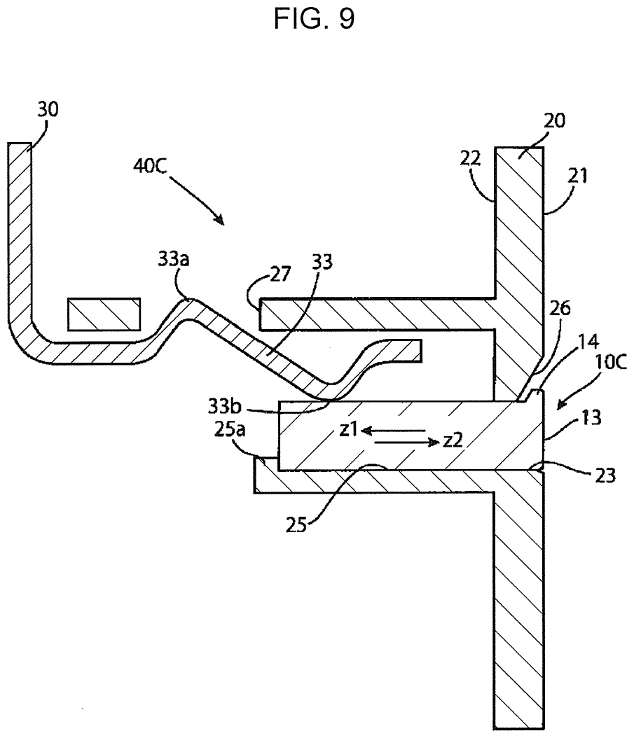

FIGS. 9 and 10 are schematic cross-sectional views of a support structure according to a third exemplary embodiment.

A support structure 40C according to a third exemplary embodiment includes a fastening hole 27 formed in the panel 20, a fastening tongue 33 included in the metal plate 30, and a fastening member 10C.

The fastening member 10C has the same shape as the fastening member 10A according to the first exemplary embodiment, illustrated in FIG. 2.

The fastening tongue 33 included in the metal plate 30 is flexible, and includes a crook 33a, protruding upward crossing an insertion/removal direction indicated with arrows z1 and z2, and a to-be-pressed portion 33b, protruding downward. The crook 33a enters the fastening hole 27. The to-be-pressed portion 33b is pressed by the arms 11 (refer to FIG. 2) of the fastening member 10C from below.

When the fastening member 10C is in a position illustrated in FIG. 9 where it is moved furthest in the direction of arrow z1, the to-be-pressed portion 33b is pressed by the fastening member 10C, and the crook 33a is kept in the fastening hole 27, so that the panel 20 is unremovably fastened to the metal plate 30. On the other hand, when the fastening member 10C is in the position, illustrated in FIG. 10, where it is moved furthest in the direction of arrow z2, the fastening tongue 33 is allowed to bend. When force is applied to the panel 20 to remove the panel 20, the crook 33a is removed from the fastening hole 27, so that the panel 20 is removed from the metal plate 30. Here, the fastening member 10C is left supported by the panel 20 while being held in the through-hole 23.

Here, in the support structure 40C according to the third exemplary embodiment, the fastening tongue 33 corresponds to an example of a third portion of the present disclosure, and the crook 33a corresponds to an example of a second hook of the present disclosure. The fastening hole 27 corresponds to an example of a fourth portion of the present disclosure. The fourth portion is not limited to the fastening hole 27, and may have any structure that interferes with the crook 33a to fasten the panel 20. For example, the fastening hole 27 may be a recess, a cut, an end surface, or a folded portion.

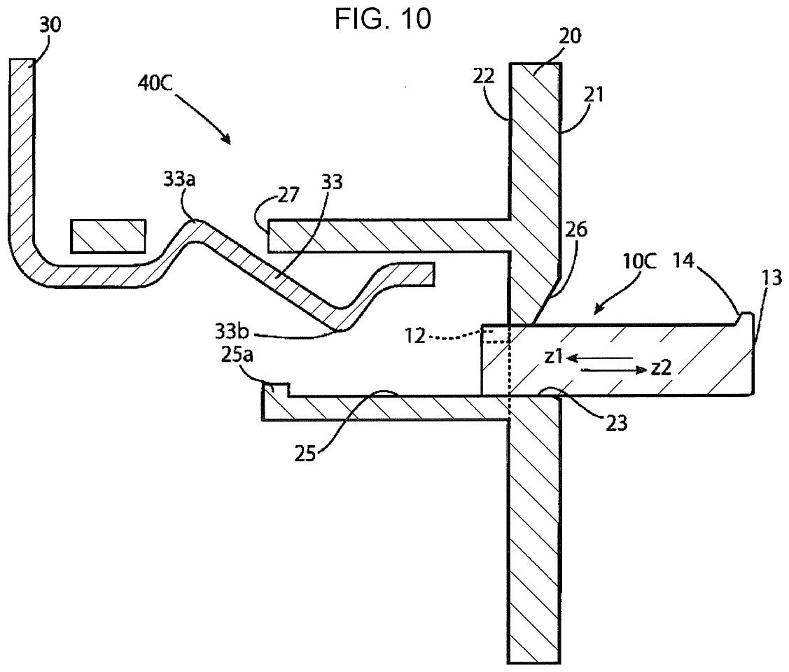

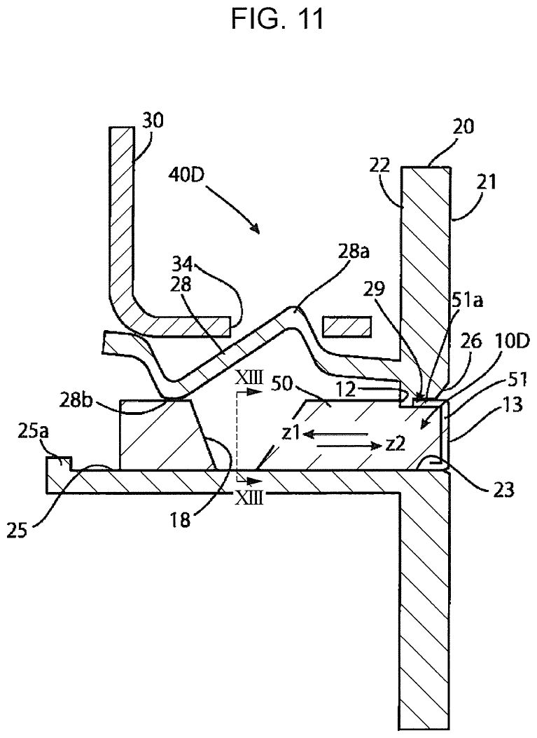

FIGS. 11 and 12 are schematic cross-sectional views of a support structure according to a fourth exemplary embodiment.

A support structure 40D according to the fourth exemplary embodiment includes an elastically bendable fastening tongue 28 included in the panel 20, a fastening hole 34 formed in the metal plate 30, and a fastening member 10D.

The fastening member 10D includes a protruding portion 12, which abuts against the back surface 22 of the panel 20 and serves as a stepped portion protruding upward. The fastening member 10D is thus not insertable into the through-hole 23 of the panel 20 from the outer surface 21 of the panel 20. As in the case of the fastening member 10B according to the second exemplary embodiment, the fastening member 10D according to the fourth exemplary embodiment is inserted into the through-hole 23 from the back surface 22 of the panel 20. The fastening member 10D has a hole 18 that extends through vertically.

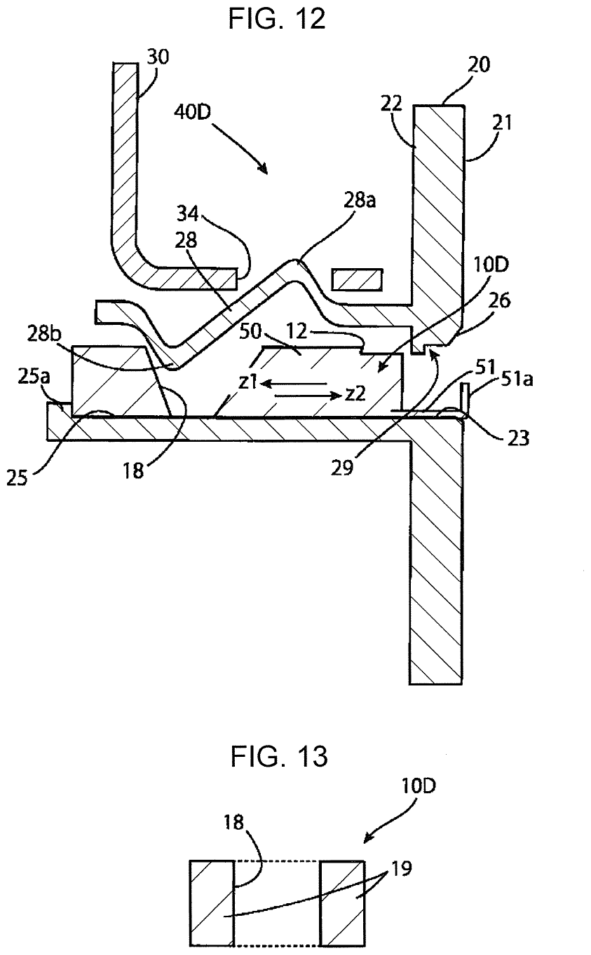

FIG. 13 is a cross-sectional view of a fastening member taken along line XIII-XIII and viewed in the direction of arrows in FIG. 11.

The hole 18 is formed at the middle in the lateral direction, defined with walls 19 on the left and right sides. Instead of the hole 18, the fastening member 10D may have a recess set back from the upper side.

The support structure 40D according to the fourth exemplary embodiment will be described further with reference back to FIGS. 11 and 12.

The fastening tongue 28 constituting the support structure 40D according to the fourth exemplary embodiment has such a width (dimension perpendicular to the plane of FIGS. 11 and 12) as to be receivable in the hole 18 of the fastening member 10D. The fastening tongue 28 includes a crook 28a, which protrudes upward to enter the fastening hole 28, and a to-be-pressed portion 28b, which protrudes downward to be pressed up by the fastening member 10D.

The fastening member 10D moves between a position illustrated in FIG. 11, to which it is moved furthest in the direction of arrow z2, and a position illustrated in FIG. 12, to which it is moved furthest in the direction of arrow z1 by being pushed further into the through-hole 23 of the panel 20. In the position illustrated in FIG. 11 where the fastening member 10D is moved furthest in the direction of arrow z2, the fastening member 10D inserts the crook 28a into the fastening hole 34 while pushing up the to-be-pressed portion 28b to elastically deform the fastening tongue 28. In this state, the panel 20 is unremovable from the metal plate 30, and is firmly fastened to the metal plate 30. Thus, in the support structure 40D according to the fourth exemplary embodiment, the position of the fastening member 10D illustrated in FIG. 11 corresponds to an example of a first position of the present disclosure.

Here, to remove the panel 20 from the metal plate 30, the fastening member 10D is pushed in the direction of arrow z1, as illustrated in FIG. 12. Thus, the fastening tongue 28 is released from elastic deformation, and the to-be-pressed portion 28b enters the hole 18 of the fastening member 10D. Thus, when force is applied to the panel 20 to remove the panel 20 after the fastening member 10D is moved to the pushed-in position illustrated in FIG. 12, the crook 28a is removed from the fastening hole 34, so that the panel 20 is removed from the metal plate 30. Here, the fastening member 10D is left supported by the panel 20 by being held between the base 25 and the fastening tongue 28 having the to-be-pressed portion 28b kept in the hole 18.

In the case of the support structure 40D according to the fourth exemplary embodiment, unlike the support structures 40A to 40C according to the first to third exemplary embodiments, the position illustrated in FIG. 12, further pushed in the direction of arrow z1 beyond the position illustrated in FIG. 11, corresponds to an example of a second position of the present disclosure.

The fastening member 10D will be described, further.

The fastening member 10D includes a belt portion 51 at the rear end. The belt portion 51 has its lower end connected to a body 50 of the fastening member 10D excluding the belt portion 51. In the state illustrated in FIG. 11, the belt portion 51 stands erect along the rear end surface of the body 50, and has an upper end 51a inserted into a recess 29 of the panel 20, located between the chamfer 26 and the through-hole 23. The surface of the belt portion 51 facing away from the surface facing the body 50 forms a rear end surface 13 of the fastening member 10D, which is flush with the outer surface 21 of the panel 20.

To push the fastening member 10D in the position illustrated in FIG. 11 further in the direction of arrow z1, the upper end 51a of the belt portion 51 is pulled out with a nail or a tool through the chamfer 26 to be in the form illustrated in FIG. 12. Then, the body 50 is pushed in the direction of arrow z1. On the other hand, to pull out the fastening member 10D in the position illustrated in FIG. 12 in the direction of arrow z2, the belt portion 51 is picked up with a nail or a finger or pulled out with a tool in the direction of arrow z2. After the belt portion 51 is pulled out until the abutting portions 12 abut against the back surface 22 of the panel 20, the upper end 51a of the belt portion 51 is inserted into the recess 29 of the panel 20 to put the belt portion 51 in the position illustrated in FIG. 11.

Here, when the belt portion 51 is in the position illustrated in FIG. 11, the belt portion 51 is prevented from being pushed in further even when, for example, the fastening member 10D is accidentally hit by some object to receive force in the direction of being pushed in the direction of arrow z1, because the upper end 51a of the belt portion 51 abuts against the bottom of the recess 29 of the panel 20.

Either the first position or the second position of the present disclosure may be a position at which the fastening member 10D arrives after moving in the direction of arrow z1 or a position at which the fastening member 10D arrives after moving in the direction of arrow z2.

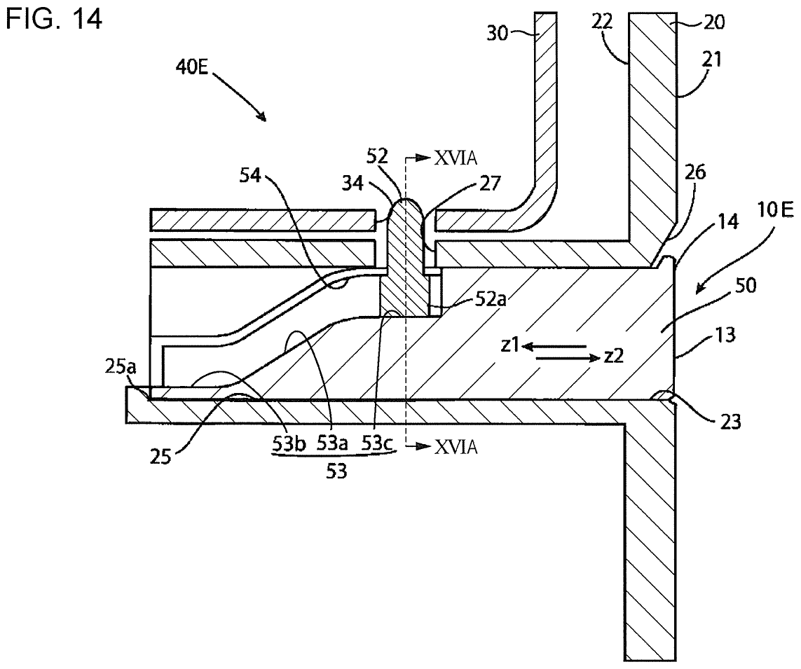

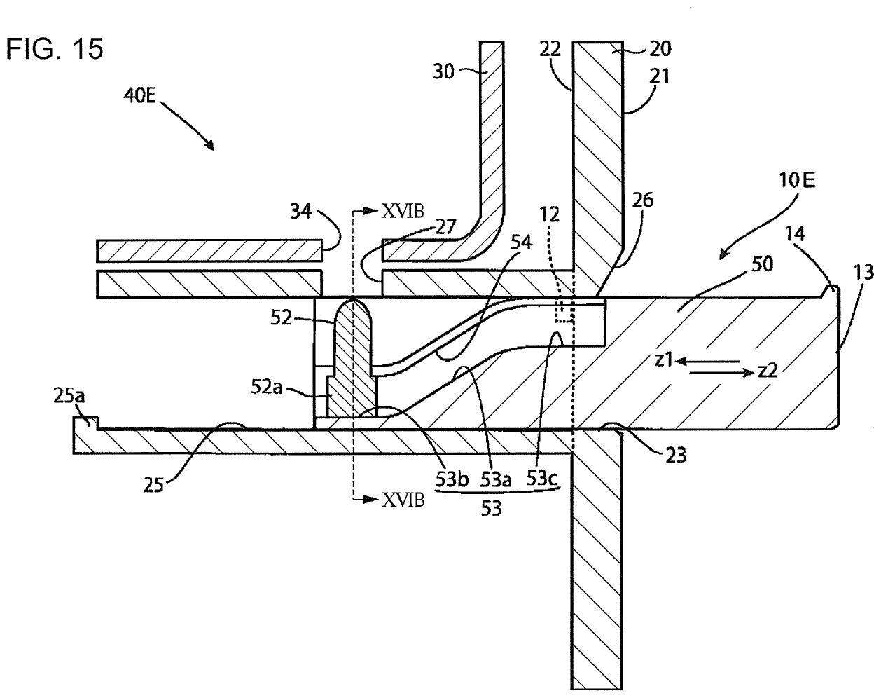

FIGS. 14 and 15 are schematic cross-sectional views of a support structure according to a fifth exemplary embodiment.

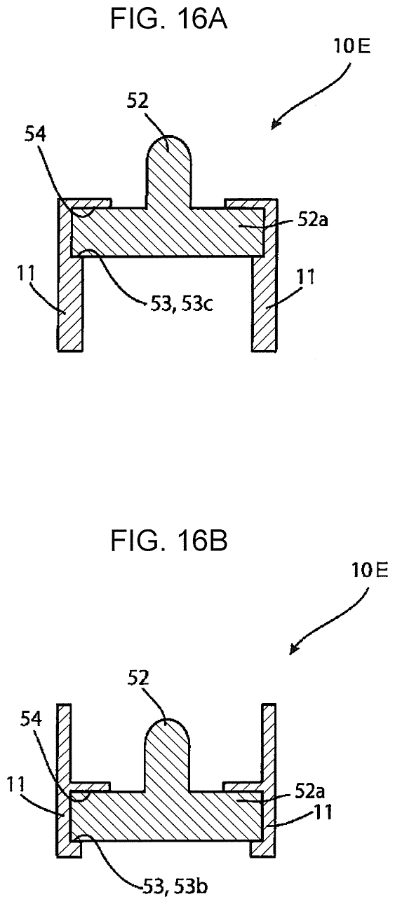

FIGS. 16A and 16B illustrate a fastening member constituting the support structure according to the fifth exemplary embodiment, where FIG. 16A is a cross-sectional view taken along line XVIA-XVIA and viewed in arrows in FIG. 14, and FIG. 16B is a cross-sectional view taken along line XVIB-XVIB and viewed in arrows in FIG. 15.

FIGS. 14 and 15 illustrate the fastening hole 27 formed in the panel 20, and the fastening hole 34 of the metal plate 30, which is continuous with the fastening hole 27. A support structure 40E according to a fifth exemplary embodiment includes these fastening holes 27 and 34 and a fastening member 10E.

The fastening member 10E includes a fastening pin 52. The fastening member 10E also includes two arms 11 extending parallel to each other in the direction of arrows z1 and z2. As in the case of the fastening member 10A illustrated in FIG. 2, these arms 11 extend in a cantilever form. The fastening pin 52 is placed in a position between pin support portions 53 and overhang portions 54 of the arms 11 while elastically deforming the arms 11 of the body 50 outward to the left and right. Here, in the case of the fastening member 10E, the arms 11 extend further in the direction of arrow z2 than those of the fastening member 10A illustrated in FIG. 2. The reason for this will be described later.

The fastening pin 52 is inserted into both fastening holes 27 and 34, as illustrated in FIG. 14. The fastening pin 52 is supported on the pin support portions 53 of the body 50 of the fastening member 10E to be movable in the direction of arrows z1 and z2. Each pin support portion 53 has a slope 53a at the middle, which is inclined downward in the direction of arrow z1, and a flat portion 53b on the side of the slope 53a in the direction of arrow z1. The pin support portion 53 also has a flat portion 53c on the side of the slope 53a in the direction of arrow z2. The flat portion 53c on the side of the slope 53a in the direction of arrow z2 is located higher than the flat portion 53b on the side of the slope 53a in the direction of arrow z1.

The fastening member 10E includes overhang portions 54, which hang over the pin support portions 53 while being spaced apart from the pin support portions 53. The distance between the pin support portions 53 and the overhang portions 54 is uniform throughout the flat portion 53c, the slope 53a, and the flat portion 53b. As illustrated in FIG. 16, the fastening pin 52 includes a mount 52a having a rectangular cross section. The mount 52a is interposed between the pin support portions 53 and the overhang portions 54. When the fastening member 10E is in the position illustrated in FIG. 14, the fastening pin 52 is inserted into the two fastening holes 27 and 34 to unremovably fasten the panel 20 to the metal plate 30.

The fastening member 10E in the position illustrated in FIG. 14 is pulled out in the direction of arrow z2 to the position illustrated in FIG. 15. Then, the fastening pin 52 is moved in the direction of arrow z1 relative to the body 50 while being held between the pin support portions 53 and the overhang portions 54. The mount 52a of the fastening pin 52, held between the pin support portions 53 and the overhang portions 54, is lowered with this movement in the direction of arrow z1 to be removed from the fastening holes 27 and 34. Thus, the panel 20 is removable from the metal plate 30.

Here, the fastening member 10E includes abutting portions 12 at the middle in the longitudinal direction indicated with arrows z1 and z2. The abutting portions 12 abut against the back surface 22 of the panel 20. The abutting portions 12 have the same shape as that illustrated in FIG. 2, and have side surfaces with a tapering chamfer shape.

The fastening member 10E also includes two arms 11 extending parallel to each other in the direction of arrows z1 and z2. The arms 11 of the fastening member 10E extend toward the rear end surface 13 of the fastening member 10E further than the arms 11 of the fastening member 10A illustrated in FIG. 2. The arms 11 each have thick end portions in the direction of arrow z1 and a thin middle portion at which the abutting portion 12 is disposed, to be bendable at the middle. The fastening member 10E is inserted into the through-hole 23 of the panel 20 from the outer surface 21 of the panel 20. In this insertion, first, the fastening pin 52 is moved in the direction of arrow z1 relative to the body 50 to lower its position. Then, the fastening member 10E is inserted into the through-hole 23 of the panel 20. When the abutting portions 12 touch the edge of the through-hole 23 of the panel 20, the two arms 11 bend toward each other, so that the abutting portions 12 cross over the through-hole 23 of the panel 20. After the abutting portions 12 cross over the through-hole 23, the arms 11 are restored. Thus, when the fastening member 10E is to be pulled out in the direction of arrow z2, the abutting portions 12 abut against the back surface 22 of the panel 20. Thus, when the panel 20 is removed from the metal plate 30, the fastening member 10E is prevented from being separated from the panel 20.

Here, in the support structure 40E according to the fifth exemplary embodiment, the fastening hole 27 of the panel 20 and the fastening hole 34 of the metal plate 30 respectively correspond to examples of a fifth portion and a sixth portion of the present disclosure, and the fastening pin 52 corresponds to an example of a seventh portion of the present disclosure. The body 50 of the fastening member 10E corresponds to an example of a base of a fastening portion of the present disclosure.

According to the above exemplary embodiments, fastening of the panel 20 to the metal plate 30 is changeable between firm fastening disabling removal and loose fastening enabling removal. According to the above exemplary embodiments, the panel 20 is removable while supporting a fastening member.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A fastening structure, comprising:
a fastening portion that moves in a movement direction between a first position and a second position, which are two positions in which the fastening portion is at least partially inserted into a hole of a to-be-supported portion, the fastening portion in the first position or the second position receiving resistance to further movement in a direction in which the fastening portion is moved to the first position or the second position, the fastening portion in the first position unremovably fastening the to-be-supported portion to a support portion, and the fastening portion in the second position allowing the to-be-supported portion to be removed from the support portion while being supported by the to-be-supported portion.

2. The fastening structure according to claim 1, further comprising a support structure that supports the to-be-supported portion on the support portion,
wherein the fastening portion in the first position causes the support structure to prevent the to-be-supported portion from being removed from the support portion, the fastening portion in the second position causes the support structure to allow the to-be-supported portion to be removed from the support portion.

3. The fastening structure according to claim 1,
wherein the to-be-supported portion includes a first surface and a second surface, and the hole extends through the first surface and the second surface,
wherein the support portion is disposed on the second surface of the to-be-supported portion,
wherein the fastening portion includes an abutting portion capable of abutting against the second surface of the to-be-supported portion,
wherein the second position is a position where the abutting portion abuts against the second surface,
wherein the first position is a position where the fastening portion is shifted from the second position in a direction from the first surface toward the second surface, and
wherein the to-be-supported portion or the support portion includes a stopper that stops the fastening portion in the first position after the fastening portion is moved to the first position.

4. The fastening structure according to claim 3,
wherein the fastening portion includes a plurality of arms extending in a cantilever form in a direction in which the fastening portion is inserted into the hole, each of the arms includes the abutting portion, and the fastening portion is insertable into the hole from the first surface while having the arms bent.

5. The fastening structure according to claim 3,
wherein the fastening portion is insertable into the hole only from the second surface.

6. The fastening structure according to claim 2,
wherein the support structure includes a first portion and a second portion, the first portion includes a first hook formed in or fixed to the to-be-supported portion, the first hook extends in a cantilever form and is flexible, the first hook protrudes in a direction crossing an insertion/removal direction corresponding to the movement direction, and the second portion is formed in or fixed to the support portion and supported by the first hook, and
wherein the fastening portion in the first position prevents the first hook from releasing the second portion, and the fastening portion in the second position allows the first hook to release the second portion.

7. The fastening structure according to claim 6,
wherein the second portion is formed from a hole, a recess, a cut, an end surface, or a folded portion formed in the support portion.

8. The fastening structure according to claim 2,
wherein the support structure includes a third portion and a fourth portion, the third portion includes a second hook formed in or fixed to the support portion, the second hook extends in a cantilever form and is flexible, the second hook protrudes in a direction crossing an insertion/removal direction corresponding to the movement direction, and the fourth portion is formed in or fixed to the to-be-supported portion and supported by the second hook, and
wherein the fastening portion in the first position prevents the second hook from releasing the fourth portion, and the fastening portion in the second position allows the second hook to release the fourth portion.

9. The fastening structure according to claim 8,
wherein the fourth portion is formed from a hole, a recess, a cut, an end surface, or a folded portion formed in the to-be-supported portion.

10. The fastening structure according to claim 3,
wherein the fastening portion includes a hook on which a finger, a nail, or a tool is hooked to move the fastening portion toward the second position, and the hook is disposed adjacent to an end surface of the fastening portion facing in the same direction as the first surface.

11. The fastening structure according to claim 10,
wherein when the fastening portion is in the first position, the end surface of the fastening portion facing in the same direction as the first surface forms part of an outer surface including the first surface, and
wherein the to-be-supported portion includes a path for the finger, the nail, or the tool hooked on the hook when the fastening portion is in the first position.

12. The fastening structure according to claim 2,
wherein the to-be-supported portion includes a first surface and a second surface, and the hole extends through the first surface and the second surface,
wherein the support portion is disposed on the second surface of the to-be-supported portion,
wherein the fastening portion includes an abutting portion capable of abutting against the second surface of the to-be-supported portion,
wherein the first position is a position where the abutting portion abuts against the second surface,
wherein the second position is a position where the fastening portion is shifted from the first position in a direction from the first surface toward the second surface, and
wherein the to-be-supported portion or the support portion includes a stopper that stops the fastening portion in the second position after the fastening portion is moved to the second position.

13. The fastening structure according to claim 2,
wherein the support structure includes a fifth portion and a sixth portion formed in each of the to-be-supported portion and the support portion, and a seventh portion included in the fastening portion to support the fifth portion and the sixth portion.

14. The fastening structure according to claim 13,
wherein the fastening portion includes a base that supports the seventh portion while allowing the seventh portion to move in an insertion/removal direction, the base causing, at least when the base is in the first position, the seventh portion to protrude in a direction crossing the insertion/removal direction, the insertion/removal direction corresponding to the movement direction, and
wherein the base in the first position causes the seventh portion to nonretractably protrude to prevent the fifth portion and the sixth portion from being removed from each other, and the base in the second position causes the seventh portion to protrude with less force than when the base is in the first position to allow the seventh portion to release the fifth portion and the sixth portion or to loosely support the fifth portion and the sixth portion so that the fifth portion and the sixth portion are removable from each other.

15. A fastening structure, comprising:
a support structure that supports a to-be-supported portion on a support portion, the to-be-supported portion including a hole; and
a fastening portion that is at least partially inserted into the hole to move between a first position and a second position, the fastening portion in the first position causing the support structure to prevent the to-be-supported portion from being removed from the support portion, and the fastening portion in the second position causing or allowing the support structure to remove the to-be-supported portion from the support portion.

16. A device, comprising:
the fastening structure according to claim 3,
wherein the first surface of the to-be-supported portion forms part of an outer surface of a housing.

17. The device according to claim 16,
wherein an end surface of the fastening portion facing the first surface when the fastening portion is in the first position forms part of the outer surface of the housing together with the first surface.

18. A fastening structure, comprising:
a fastening portion that moves in a movement direction between a first position and a second position, which are two positions in which the fastening portion is at least partially inserted into a hole of a to-be-supported portion, the fastening portion in the first position receiving resistance to further movement and further insertion in a direction in which the fastening portion is moved to the first position, the fastening portion in the first position unremovably fastening the to-be-supported portion to a support portion, and the fastening portion in the second position causing or allowing the to-be-supported portion to be removed from the support portion,
wherein part of the fastening portion forms part of a surface of the to-be-supported portion.

19. The fastening structure according to claim 18,
wherein when the fastening portion is in the first position, the fastening portion forms a gap to allow a nail or tool to be hooked on the fastening portion.
